(19) United States
(12) Patent Application Publication
(10) Pub. No.: US 2005/0236963 A1
(43) Pub. Date: Oct. 27, 2005

(54) Emitter structure with a protected gate electrode for an electron-emitting device

(76) Inventors: Sung Gu Kang, San Jose, CA (US); Woo Kyung Bae, Campbell, CA (US); Jong Woo Son, San Jose, CA (US); Chul Ha Chang, San Jose, CA (US); Jung Jae Kim, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/107,407

(22) Filed: Apr. 14, 2005

Related U.S. Application Data
(60) Provisional application No. 60/563,075, filed on Apr. 15, 2004.

(51) Int. Cl. H01J 1/62; H01J 1/02; H01J 63/04

(52) U.S. Cl. 313/495; 313/496; 313/311; 313/309

(57) ABSTRACT

A cathode structure of a field emission device includes a gate electrode that is protected by a passivation layer. In one method for manufacturing such a field emission device, an emitter hole is formed through an insulating layer such that the passivation layer overhangs the gate layer, which overhangs an insulating layer. When used in a display system, the gate layer is exposed to an emitter electrode but shielded from an anode.

### CROSS REFERENCE TO RELATED APPLICATIONS

This application claims the benefit of U.S. Provisional Application No. 60/563,075, filed Apr. 15, 2004, which is incorporated by reference in its entirety.

### BACKGROUND

1. Field of the Invention

This invention relates generally to field emission devices, and in particular to cathode structures for field emission devices having protected gate electrodes.

2. Background of the Invention

Flat panel displays (FPDs) using carbon nanotube (CNT) technology are replacing and superseding existing display technologies, including those that use cathode ray tubes (CRTs), thin film transistor liquid crystals (TFT-LCDs), plasma display panels (PDPs), and organic light emitting diodes (OLEDs). The emerging CNT-based flat panel display technology uses a process for generating pictures similar to the method used in CRTs. But instead of a CRT's single hot filament electron gun, CNT-based displays use a planar array of carbon nanotube emitters as a source of electrons.

In one example, a CNT-based field emission display comprises a cathode structure (also called an emitter structure) disposed on a back plate and an anode structure on an opposing faceplate. The cathode structure includes a matrix of row electrodes and column electrodes (either of which may be emitter or gate electrodes). Electron emitters, such as CNTs, are disposed within cavities or holes in the cathode structure that correspond to particular pairs of row and column electrodes. When an appropriate voltage is applied between a particular row and column electrode, electrons are emitted from the emitters corresponding to that pair of row and column electrodes. These emitted electrons are accelerated towards the anode structure on the faceplate by an electric field, normally created by a combination of the anode and the row and column electrodes. The anode structure includes color elements (e.g., phosphors), each of which absorbs the energy from the emitted electrons and emits light of a particular color. This light, when combined with the light from other color elements, creates an image on the display.

The display can be matrix-addressed by applying voltages to each of its row and column electrons to control precisely the electron emission of the emitters for any particular row and column. The intersection of a row line and a column line in the matrix defines a picture element, or sub-pixel, the smallest addressable element in an electronic display. In a typical color display system, each pixel includes three picture elements corresponding to the pixel's component colors (e.g., red, green, and blue). Controlling the emission of electrons of each picture element controls the light intensity of each picture element and, in turn, the color of each pixel and the overall picture on the display. By matrix-addressing each picture element or pixel of the display, any desired refresh rate can be accomplished.

In the field emission display described above, each picture element has its own source of electrons—the set of emitters that corresponds to a particular row and column electrode pair. This provides a highly redundant electron source for the display. Compared to competing technologies, CNT-based field emission displays provide pristine picture quality, robust video response, wide viewing angles, and low power consumption. This alleviates the size, weight, and power limitations of a conventional CRT, while providing higher picture quality, lower manufacturing cost, and more efficient power consumption than LCDs.

A problem arises in the design of such displays, however, due to their use of electric fields between the emitters and the other electrodes to cause emission of the electrons for driving the display. In many existing embodiments of field emission devices sealed in vacuum envelopes, a gate electrode in the cathode structure is exposed to the conductive portions of a highly charged faceplate structure. In operation of such a device, a voltage potential serving as a control signal is applied to the exposed gate electrode. The gate electrode is typically the uppermost electrode in the cathode structure, which is used for controlling the emission of electrons (and thus the image of a display when the electron-emitting device is used in a field emission display system). A high voltage potential is then applied to the black matrix of a faceplate (or anode) structure, causing emitted electrons to be accelerated from the cathode structure towards the faceplate.

Due to the exposure of the gate electrode to the high voltage anode structure of the faceplate within the vacuum-sealed portions of a field emission device, arcing may occur between the gate electrode and the anode structure. This arcing is an electrical breakdown in the vacuum envelope with a high voltage anode, caused by the significant difference in electrical potential between the gate and anode electrodes. In vacuum electronics, electrical arcing can be a critical problem for the proper operation of field emission electron-emitting devices. As described, the arcing problem is related to the varying potentials of the cathode, faceplate, and spacer materials and structures, and specifically to the two electrodes that are commonly found therebetween—the gate electrode of the cathode and the anode electrode of the faceplate.

Previous solutions to the arcing problem have employed an insulating passivation layer above the gate electrode to prevent arcing. But these solutions have left portions of the gate layer exposed and have therefore not fully prevented arcing between the gate electrode and anode.

### SUMMARY OF THE INVENTION

To address this arcing problem, a cathode structure for an electron-emitting device includes a passivation layer, or other dielectric or insulating material, situated over or otherwise protecting the gate layer. To minimize exposure of the gate electrode to the anode while allowing exposure of the gate electrode for providing an electric field for drawing electrons from the emitter, the passivation layer covers and overhangs the gate layer on a top side thereof. This leaves an underside or other portion of the gate electrode exposed to the emitter structure while still protected from the anode structure. The passivation layer covers the gate electrode at least in part to inhibit arcing between the gate electrode and the anode structure.

The cathode structure can be used to supply electrons for lighting a picture element in a display system, such as a CNT flat panel display. In one embodiment, a display system comprises a matrix of pixels, each pixel having one or more picture elements. For each picture element of each pixel, the display system comprises a color element that emits light when excited by electrons and an electron emitting device as described herein and configured to emit electrons towards the color element, thereby causing the color element to emit light.

In another embodiment, a method for making a cathode structure having an overhanging passivation layer comprises forming an emitter electrode on a substrate, forming an insulating layer over the emitter electrode, forming a gate electrode over the insulating layer, forming a passivation layer over the gate electrode, and forming at least one emitter hole through the insulating layer and the passivation layer (and possibly through the gate electrode). The passivation layer is formed so that it overhangs the gate electrode over the emitter hole or otherwise protects the gate electrode from arcing with an anode placed opposite the cathode structure. In one embodiment, where the emitter hole is formed by etching, the passivation layer and the insulating layer are selected so that the passivation layer has a higher etch selectivity relative to the insulating layer.

### BRIEF DESCRIPTION OF THE DRAWINGS

FIG. 1 is a cross sectional view of a cathode structure for a field emission device, in accordance with an embodiment of the invention.

FIGS. 2A through 2F illustrate a method for manufacturing the cathode structure of the device shown in FIG. 1, in accordance with one embodiment of the invention.

FIG. 3 is a top view of an example field emission device, such as a display system, in accordance with an embodiment of the invention.

### DETAILED DESCRIPTION OF THE PREFERRED EMBODIMENTS

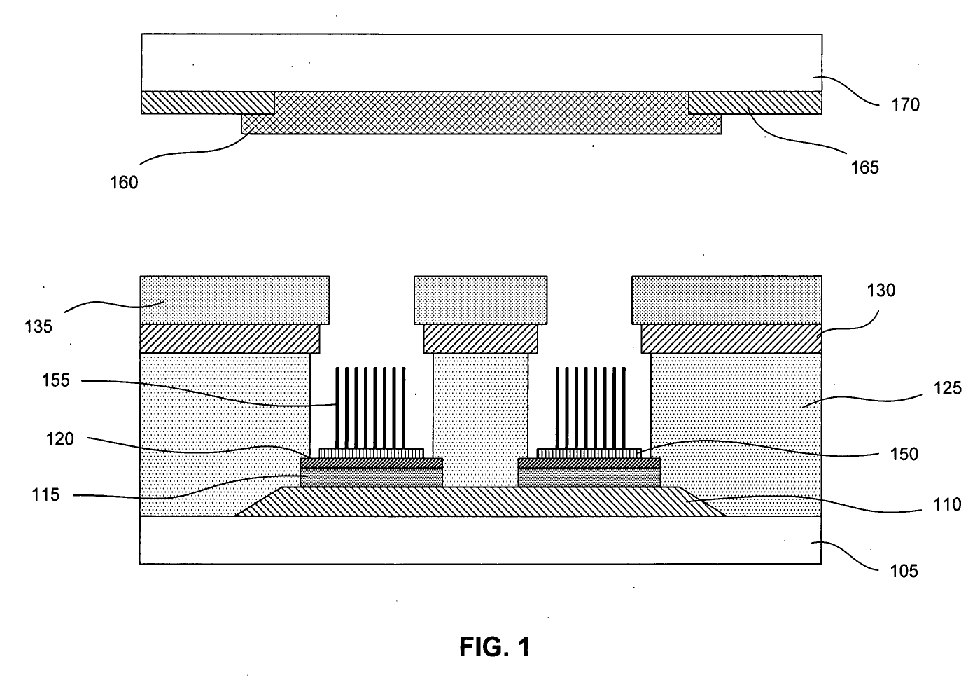

FIG. 1 illustrates one embodiment of a field emission device for emitting electrons, such as a portion of a CNT-based field emission display described above. The field emission device shown in FIG. 1 comprises two main structures: a cathode structure and an anode structure. The cathode structure includes a number of layers of material deposited over a substrate 105, such as glass. In one embodiment, the layers of the cathode structure include an emitter electrode 110, a resistor layer 115, a barrier layer 120, an insulating (or dielectric) layer 125, a gate electrode 130, and a passivation layer 135. The cathode structure further comprises electron emitters 155, such as carbon nanotubes, which are situated in one or more emitter holes formed through a portion of the cathode structure. Preferably, the electron emitters 155 are disposed on or in electrical coupling with the emitter electrode 110. The electron emitters may be formed from a catalyst layer 150, which rests over the barrier layer 120.

In an embodiment in which the field emission device is to be used in a display system, the cathode structure lies opposite a corresponding anode structure, as shown. The anode structure comprises an anode 165 and a color element 160, such as a phosphor, both of which are disposed on a faceplate 170. Preferably, the faceplate 170 is made of a transparent material, such as glass, so that light emitted from the color element 160 can shine through the faceplate 170. This enables the field emission device to generate a colored pixel of an image when the color element 160 is excited by electrons emitted from the emitters 155.

A bottom or underside of the gate electrode 130 is exposed (e.g., without electrical insulation) at least in localized areas near the emission elements 155 of the cathode structure. In this way, a voltage applied between the gate electrode 135 and the emitter electrode 110 creates an electrical field therebetween. If sufficient to overcome the work function of the emitters 155, this enables the gate electrode 130 to create an electrical field to cause electron emission from the electron-emission elements. For proper exposure, the gate electrode 135 may overhang the emitter hole, a cavity formed through the insulating layer 125 in which the emitters 155 are situated, although other means of exposure may be provided.

Although exposed to the emitters hole, the gate electrode 130 is preferably protected from exposure to the anode 165 to prevent arcing therebetween. Accordingly, passivation layer 135 is situated over and overhangs the gate electrode 130. The passivation layer 135 may comprise one or more of a number of dielectric or insulating materials. By covering a top surface of the gate electrode 130 with the passivation layer 135 or other insulation means, the electric field that could cause arcing between the gate electrode 130 and the anode 165 is significantly reduced. Beneficially, reducing this electric field for a given set of conditions allows the anode voltage to be increased. A higher anode voltage allows for increased acceleration of emitted electrons from the cathode, resulting in higher brightness and generally improved performance of the display.

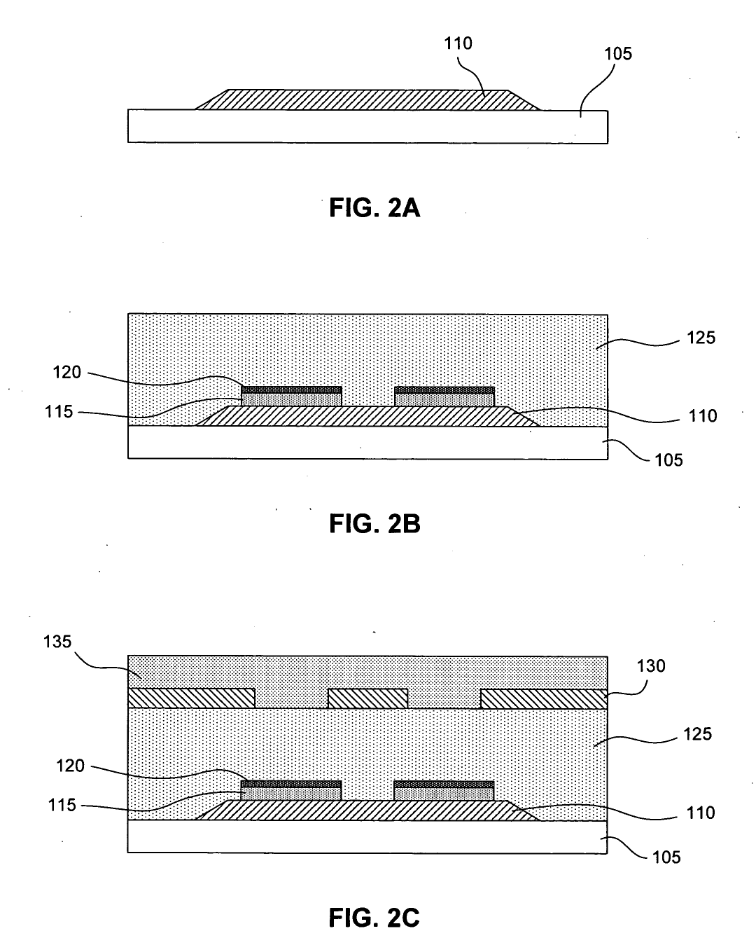

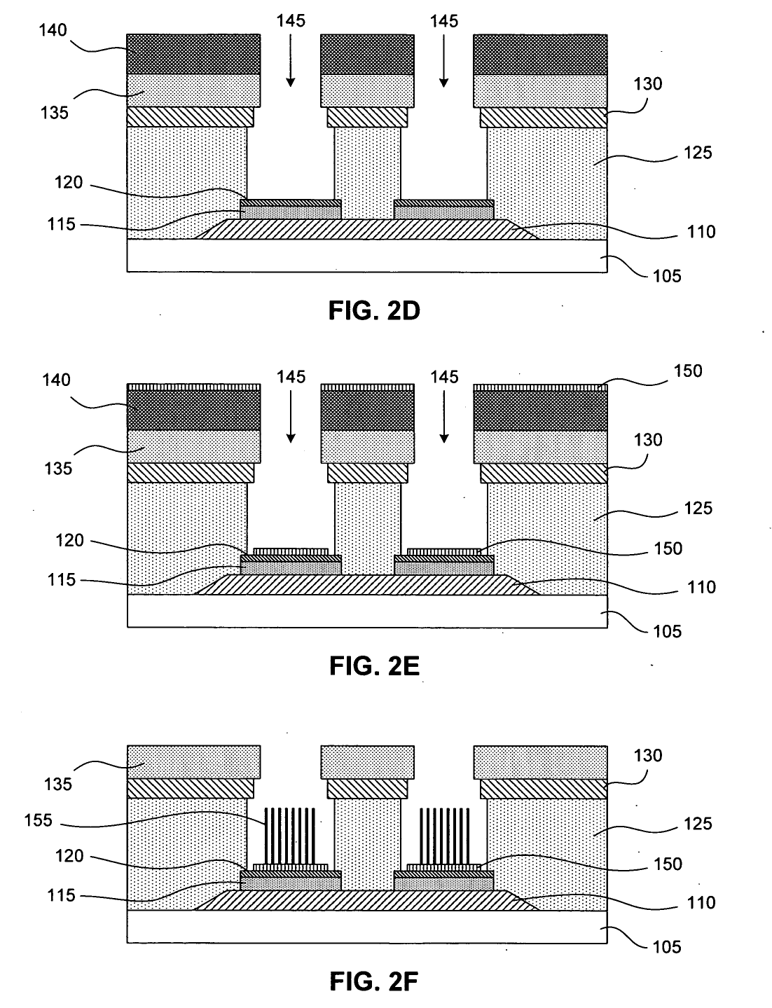

FIGS. 2A through F illustrate an embodiment of a process for making a cathode structure such as the one illustrated in FIG. 1. The steps for forming the various layer and components of the cathode structure are explained for illustration purposes only, and any of the steps can be substituted for other processes to produce the same or equivalent structures. Moreover, certain steps (such as those used for forming the catalysts or barrier layers) may be skipped, and others may be added to achieve any desired cathode structure.

FIG. 2A illustrates a step of patterning an emitter electrode 110, in which electrode material is deposited on the substrate 105. The emitter electrode 110 can be deposited by any known technique, for example by a sputtering process, and can further be patterned with a photolithography process. The material for the emitter electrode 110 is an electrically conductive material, such as chromium (Cr). Preferably, the material is chosen to have a high selectivity during the etching process steps of latter applied materials, described below.

In FIG. 2B step, the resistive layer 115 and the diffusion barrier layer 120 are formed. In one embodiment, the resistive layer 115 comprises a semiconductor material such as a-Si, and the barrier layer 120 comprises a metal such as chromium (Cr) or titanium tungsten (TiW). The resistive layer 115 may be deposited by a process such as PECVD (plasma enhanced chemical vapor deposition), and the barrier layer 120 may be deposited by a sputtering process. The resistive layer 115 and barrier layer 120 may be patterned as two films using the same photo mask, which in one embodiment includes “island” patterns on the emitter electrode 110. To etch these materials, wet etching may be performed for the barrier layer 120 and dry etching may be performed for the resistive layer 115. After the barrier and resistive layers 115 and 120 are patterned, an insulator 125 is deposited, for example by a CVD process. In different embodiments, the insulator 125 comprises SiOₓ or SiOₓN_{y}, and the insulator's thickness is in a range of about 500 nm to about 2000 nm.

FIG. 2C illustrates the formation of the gate electrode 130 and the passivation layer 135 onto the cathode structure, in accordance with one embodiment. A conductive material, such as chromium (Cr), is deposited on the insulator 125 to form the gate electrode 130. This depositing may be accomplished using a sputter process. In one embodiment, the gate electrode 130 is patterned as a strip that is perpendicular to the emitter electrode 110, and in another photolithography is used to provide a hole pattern in the gate electrode 135. For example, after the photolithography, the gate material 135 is etched with a wet etching process, and the photo resist is stripped. In one embodiment, the holes patterned in the gate electrode 130 are positioned over the emitter electrode 110.

After the gate electrode 130 is patterned, a passivation layer 135 is deposited thereover. In one embodiment, the passivation layer 135 comprises silicon nitride (SiN). The passivation layer 135 may alternatively comprises one or a combination of a number of other insulator materials. In one embodiment, the passivation layer 135 has a thickness is in the range of about 100 nm to about 1000 nm.

As shown in FIG. 2D, after the deposition of passivation material 135, a number of emitter holes 145 are formed through at least a portion of the cathode structure. To form the holes 145, in one embodiment, photolithography is performed, in which a photoresist pattern 140 is formed over the passivation layer 135. In one embodiment, the diameter of the photoresist pattern 140 is less than the diameter of the holes patterned in the gate electrode 135, so that the photoresist pattern 140 overhangs the gate electrode 130. A dry etch process is then performed to etch the passivation layer 135, and then a wet etch process is performed to etch the insulator layer 125. In one embodiment, BHF chemical is used for the wet etching of the insulator material 125. After etching the passivation layer 135 and the insulator 125, an emitter hole (or cavity) 145 is formed for each hole in the photoresist pattern 140. The diameter of the emitter hole 145 may vary throughout the layers of the cathode structure.

In one embodiment, so that the gate layer 130 is covered on a top side by the passivation layer 135 but exposed on a bottom side by the insulating layer 125, the passivation layer 135 is selected to have a higher etch selectivity relative to the etch selectivity of the insulating layer 125 (in the BHF wet etching process or whichever etch is performed). In this way, the etching process removes the insulating layer 125 faster than the passivation layer 135, so that the process can be stopped when the desired structure is obtained. In one embodiment, the ratio of the etch selectivity of the passivation layer 135 to the insulating layer 125 is in the range of about 2 to about 20.

As shown in FIG. 2E, a catalyst layer 150 is then formed on the barrier layer 120. In one embodiment, the catalyst layer 150 is deposited continuously over the entire substrate, including the photoresist pattern 140. The photoresist 140 is then stripped, and any catalyst material 150 on the photoresist 140 is removed while leaving the portions of the catalyst layer 150 that are deposited on the barrier layer 120. In one embodiment, the substrate is treated with BHF to remove any residual catalyst material on the passivation layer 135 and insulating layer 125, except for the catalyst on the barrier layer.

With the catalyst layer 150 formed, the electron-emitting elements 155 are grown, as shown in FIG. 2F. In one embodiment, the electron-emitting elements 155 are carbon nanotubes (CNTs). In one embodiment, the electron-emitting elements 155 are grown on the catalyst material 150 using a PECVD process. For growing CNTs, the emitting elements 155 may be grown using hydrocarbon gases, such as C₂H₂ or CH₄.

In an alternative embodiment, the gate electrode 130 is initially deposited over the insulating layer 125 as a continuous strip, without any holes patterned over the emitter electrode 110. Accordingly, the process of forming the holes 145 through the passivation layer 135 and insulating layer 125 (e.g., using the photoresist pattern 140) further includes forming the corresponding holes through the gate electrode 130. Forming the holes through each of these layers using the same photoresist pattern 140 may help to align the holes through each layer and thus produce a more uniform cavity 145.

Although various embodiments for forming the cathode structure for a field emission device have been described and illustrated, it can be appreciated that any number of variations can be made to these while achieving the benefit of protecting the gate electrode to avoid electrical arcing and shorting. Various embodiments of electron-emitting devices that can be used in conjunction with or modified by the improved cathode structure described herein as well as various processes for producing a cathode structure suitable for a field emission device (such as a display system) are described in the following, each of which is incorporated by reference in its entirety: U.S. application Ser. No. 10/080,057, filed Feb. 20, 2002; U.S. application Ser. No. 10/080,012, filed Feb. 20, 2002; U.S. application Ser. No. 10/302,126, filed Nov. 22, 2002; U.S. application Ser. No. 10/226,405, filed Aug. 22, 200; U.S. application Ser. No. 10/226,873, filed Aug. 22, 2002; U.S. application Ser. No. 10/327,529, filed Dec. 20, 2002; U.S. application Ser. No. 10/600,226, filed Jun. 19, 2003; U.S. application Ser. No. 10/807,485, filed Mar. 27, 2004; and U.S. application Ser. No. 10/952,352, filed Sep. 27, 2004.

Embodiments of the field emission devices can be used in display systems, such as matrix-addressable CNT-based field emission display. For example, the device illustrated in FIG. 1 may be a part of a display system in which electrons are emitted and accelerated towards an anode structure containing color elements (e.g., phosphors). The structure shown in FIG. 1 typically corresponds to a single picture element, or subpixel, of the display. A number of groups of emitters, comprising for example carbon nanotubes, are situated within corresponding emitter holes, or cavities, in the cathode structure. Each of the groups of emitters for a given picture element are indexed by an emitter electrode and gate electrode, which typically run perpendicular in a matrix-addressable display system. Although only two groups of emitters and cavities are illustrated, a typical display includes a large number of emitter holes (e.g., tens or hundreds) for each picture element.

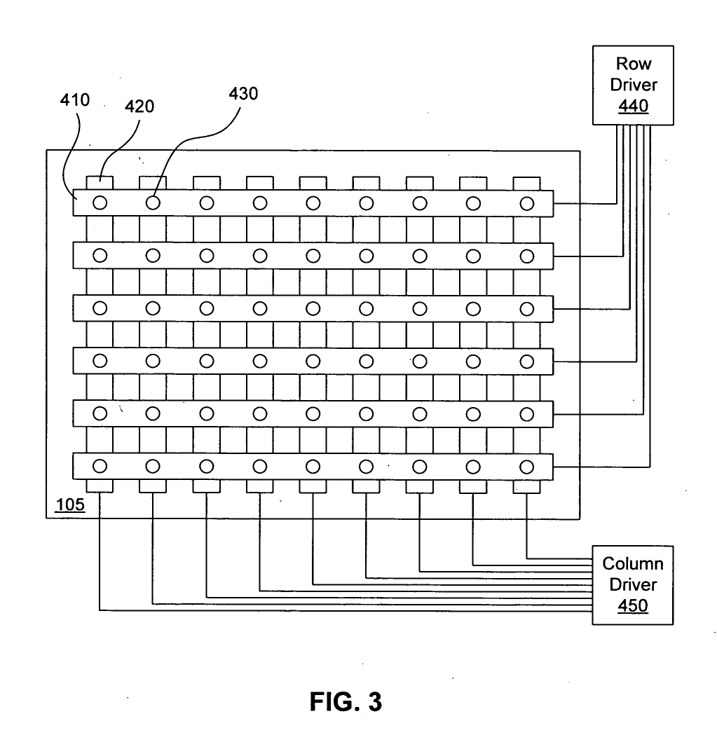

FIG. 3 shows a top view of the back plate and cathode structure of one embodiment of such a display system. For simplicity, not all layers of the cathode structure are illustrated. The back plate includes a plurality of row electrodes 410 and column electrodes 420, with sets of electrons emitters situated in emitter holes 430. As shown in FIG. 3, the row electrodes 410 are gate electrodes column electrodes 420 are emitter electrodes; however, these may be reversed in other embodiments. In essence, the back plate structure comprises a plurality of field emission devices, such as those described above, in a matrix arrangement on the back plate of the display. In the display system, each pair of a row electrode 410 and a column electrode 420 indexes a single picture element of the display.

The emitters associated with a picture element can be made to emit electrons (toward an anode on a faceplate structure, not shown) through appropriate driving of the row driver 440 and column driver 450, which are coupled to the row electrodes 410 and column electrodes 420, respectively. When an appropriate voltage is applied between a particular row and column electrode 410 and 420, electrons are emitted from the emitters corresponding to that pair of row and column electrode 410 and 420. In this way, the display is matrix-addressable to control precisely the electron emission of the emitters for each row and column. The emitted electrons are accelerated towards an anode structure on the faceplate by an electric field. The anode structure includes a plurality of color elements (e.g., phosphors), which absorb the energy from the emitted electrons and emit light of a particular color. In a typical color display system, each pixel includes three picture elements corresponding to the pixel's component colors (e.g., red, green, and blue). Controlling the emission of electrons of each picture element thus controls the light intensity of each picture element and, in turn, the color of each pixel and the overall picture on the display.

As used herein, the terms situated over, formed over, and overlying, as well as other terms applied to layers, are not meant to limit the structure such that the layers must necessarily be directly over one another or that the layers must be in physical contact, unless expressly disclosed as such. Where one layer is over another layer, in any sense, there may exist other layers between those layers. Moreover, two layers need not be coextensive, or even overlap, for one layer to be over the other. These terms thus refer to the layers' respective ordering in various embodiments of the devices described herein, and should be understood in the broad context of the disclosure.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. For example, the insulator layer may be a single material, more than two layers of distinct materials, or a material with continuously varying properties. Moreover, additional layers may be used, layers may be eliminated, and the layers may be ordered differently. It is therefore intended that the scope of the invention be limited not by this detailed description, but rather by the claims appended hereto.

1. An electron-emitting device comprising:
an emitter electrode;
an insulating layer disposed over the emitter electrode, the insulating layer having an emitter hole formed therethrough;
a plurality of electron emitters electrically coupled to the emitter electrode and situated within the emitter hole;
a gate electrode having a section thereof exposed to the emitter hole; and
an electrically insulating passivation layer disposed over and overhanging the gate layer, the passivation layer for inhibiting electrical arcing therethrough from the gate electrode.

2. The device of claim 1, wherein the passivation layer comprises SiN.

3. The device of claim 2, wherein the passivation layer has a thickness within a range of about 100 nm to about 1000 nm.

4. The device of claim 1, wherein the insulating layer has a thickness within a range of about 500 nm to about 2000 nm.

5. The device of claim 4, wherein the insulating layer comprises SiOₓ.

6. The device of claim 4, wherein the insulating layer comprises SiOₓN_{y}.

7. The device of claim 1, wherein the electron emitters are carbon nanotubes.

8. An electron-emitting device comprising:
an emitter electrode;
an insulator disposed over the emitter electrode, the insulator having one or more emitter holes exposing an electrical connection to the emitter electrode;
a plurality of electron emitters disposed within the emitter holes and electrically coupled to the emitter electrode;
a gate electrode overlying the insulator and having holes formed therethrough corresponding to the emitter holes of the insulator, the gate electrode electrically exposed to the emitter electrode to allow an electrical field therebetween; and
a passivation layer overlying and covering the gate electrode, the passivation layer having holes formed therethrough corresponding to the emitter holes of the insulator, the holes in the passivation layer having a smaller diameter than the holes of the gate electrode.

9. The device of claim 8, wherein the passivation layer comprises SiN.

10. The device of claim 9, wherein the passivation layer has a thickness within a range of about 100 nm to about 1000 nm.

11. The device of claim 8, wherein the insulating layer has a thickness within a range of about 500 nm to about 2000 nm.

12. The device of claim 11, wherein the insulating layer comprises SiOₓ.

13. The device of claim 11, wherein the insulating layer comprises SiOₓN_{y}.

14. An electron-emitting device comprising:
an emitter electrode;
a plurality of electron emitters electrically coupled to the emitter electrode;
a gate electrode disposed over the emitter electrode in proximity to the electron emitters;
an anode opposing the emitter electrode; and
means for inhibiting arcing between the gate electrode and the anode when the gate electrode and anode are held at an electrical potential relative to each other.

15. The device of claim 14, wherein the electron emitters are carbon nanotubes.

16. A display system comprising a matrix of pixels, each pixel having one or more picture elements, and for each picture element of each pixel the display system comprises:
a color element that emits light when excited by electrons; and
the electron-emitting device of any one of the previous claims, the electron-emitting device configured to emit electrons towards the color element, thereby causing the color element to emit light.

17. A method for forming a field emission device, the method comprising:
forming an emitter electrode on a substrate;
forming an insulating layer over the emitter electrode;
forming a gate electrode over the insulating layer;
forming a passivation layer over the gate electrode; and
forming at least one emitter hole through the insulating layer and the passivation layer so that the passivation layer overhangs the gate electrode over the emitter hole.

18. The method of claim 17, wherein the emitter hole is formed by etching.

19. The method of claim 18, wherein the passivation layer and the insulating layer are selected so that the passivation layer has a higher etch selectivity relative to the insulating layer.

20. The method of claim 19, wherein the ratio of the etch selectivity of the passivation layer relative to the insulating layer is between about 2 to about 20.

21. The method of claim 17, wherein the passivation layer comprises SiN.

22. The method of claim 21, wherein the passivation layer has a thickness within a range of about 100 nm to about 1000 nm.

23. The method of claim 17, wherein the insulating layer has a thickness within a range of about 500 nm to about 2000 nm.

24. The method of claim 23, wherein the insulating layer comprises SiOₓ.

25. The method of claim 23, wherein the insulating layer comprises SiOₓN_{y}.

26. The method of claim 17, wherein the electron emitters are carbon nanotubes.

27. The method of claim 17, wherein forming at least one emitter hole through the insulating layer and the passivation layer is accomplished using a photoresist pattern.

28. The method of claim 27, wherein the photoresist pattern is used to form holes through the gate electrode.
